(19) United States
(12) Patent Application Publication
(10) Pub. No.: US 2023/0241759 A1
(43) Pub. Date: Aug. 3, 2023

(54) WORK TABLE SIDE RAIL

(71) Applicant: Mark T. Miller, Santa Monica, CA (US)

(72) Inventor: Mark T. Miller, Santa Monica, CA (US)

(21) Appl. No.: 18/103,645

(22) Filed: Jan. 31, 2023

Related U.S. Application Data
(60) Provisional application No. 63/305,857, filed on Feb. 2, 2022.

(51) Int. Cl. B25H 1/08; B25H 1/02

(52) U.S. Cl. CPC B25H 1/08; B25H 1/02

(57) ABSTRACT

A work table is disclosed. The work table may include legs and a frame supported by the legs in a vertical direction. The frame may include an outer side rail with a first slot and a second slot. The first slot may include a first T-slot and the second slot may include a second T-slot. The first T-slot and the second T-slot may be configured to receive protrusions (e.g., T-Bolts) of one or more attachments. The first slot and the second slot may be configured to receive the one or more attachments from an outward facing direction that is perpendicular to the vertical direction.

### CROSS-REFERENCE TO RELATED APPLICATION

The present application claims the benefit under 35 U.S.C. § 119(e) of U.S. Provisional Patent Application Ser. No. 63/305,857, filed on Feb. 2, 2022, entitled WORKBENCH AND ACCESSORIES, which is incorporated herein by reference in the entirety.

### TECHNICAL FIELD

The present disclosure relates generally to side rails of tables and, more particularly, to a side rail configured to receive one or more attachments.

### BACKGROUND

Work tables are commonly used in a variety of applications, such as in job sites, workshops, offices, schools, and homes. These tables are often heavy-duty, constructed with a rigid frame, and designed to support a large amount of weight.

However, work tables do not always have all desired functionalities. For example, work tables may not have the necessary space to place tools if the work table is occupied by a sheet of plywood. On the other hand, permanent brackets on the side to hold tools or work product may be damaged if the work table is placed on its side for storage.

Therefore, a desire may exist to provide a work table or a side rail of a work table that overcomes the limitations of the prior art. Moreover, a need may exist to provide a work table or side rail of a work table that allows for flexibility depending on the application for a wide variety of functionalities and storage.

For purposes of the present disclosure, “swaging” and the like includes, but is not necessarily limited to, cold forming processes, such as cold rolling, cold drawing, and the like.

### SUMMARY

A work table is disclosed in accordance with one or more illustrative embodiments of the present disclosure. In one illustrative embodiment, the work table may include legs and a frame supported by the legs in a vertical direction. In another illustrative embodiment, the frame may include an outer side rail with a first slot and a second slot. In another illustrative embodiment, the first slot may include a first T-slot and the second slot may include a second T-slot. In another illustrative embodiment, the first T-slot and the second T-slot may be configured to receive T-bolts of one or more attachments. In another illustrative embodiment, the first slot and the second slot may be configured to receive the one or more attachments from an outward facing direction that is perpendicular to the vertical direction.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a work table with an outer side rail, in accordance with one or more embodiments of the present disclosure.

FIG. 1B is an enlarged view of the work table illustrating a first slot and a second slot of the outer side rail, in accordance with one or more embodiments of the present disclosure.

FIG. 1C is a view of a cross-sectional area of the outer side rail, in accordance with one or more embodiments of the present disclosure.

FIG. 1D is the outer side rail including cross member voids, in accordance with one or more embodiments of the present disclosure.

FIG. 1E is a frame, in accordance with one or more embodiments of the present disclosure.

FIG. 2A is the work table including a wheel attachment, in accordance with one or more embodiments of the present disclosure.

FIG. 2B is a side view of the work table including the wheel attachment, in accordance with one or more embodiments of the present disclosure.

FIG. 2C is an exploded assembly view of the wheel attachment, in accordance with one or more embodiments of the present disclosure.

FIG. 3 is the work table including a bracket attachment, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to side rails (e.g., side rails extending lengthwise, end side rails extending widthwise, and the like) configured to receive one or more attachments.

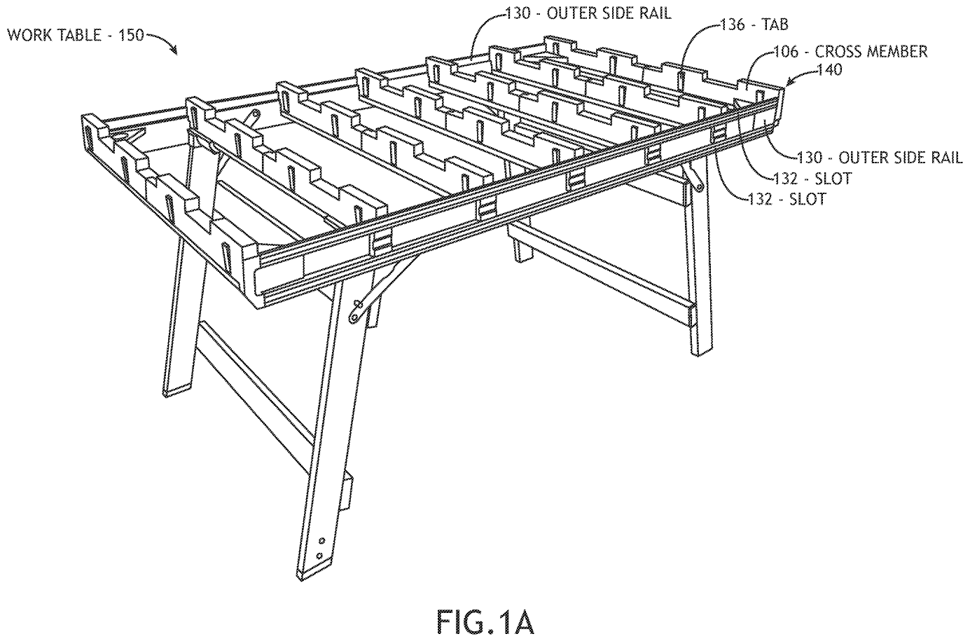

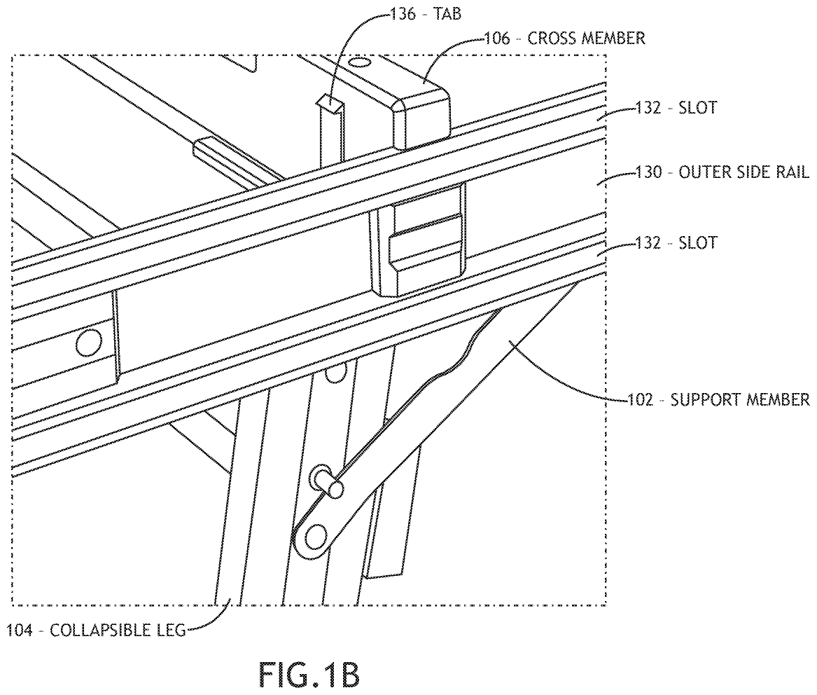

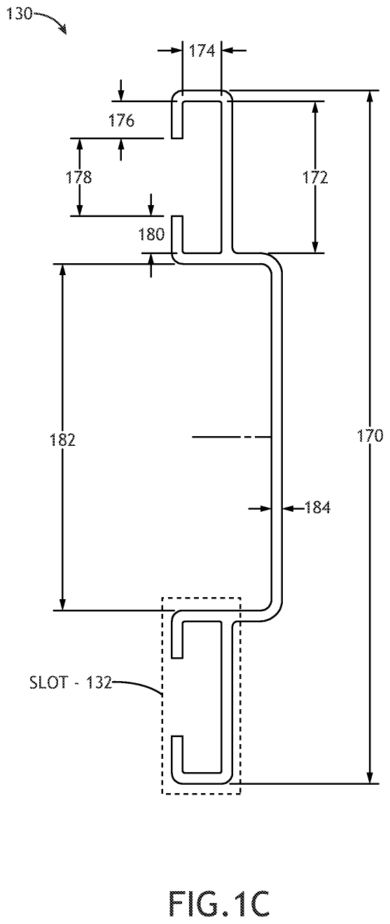

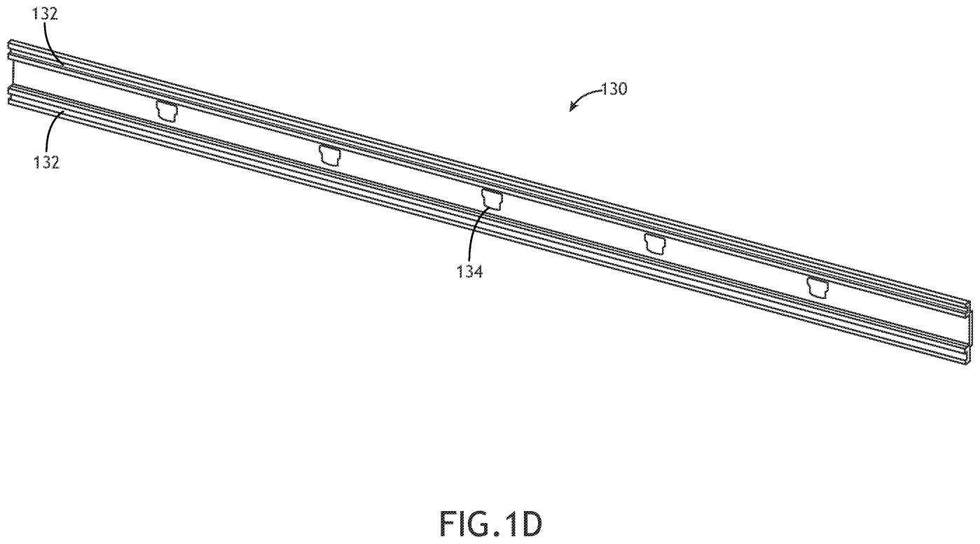

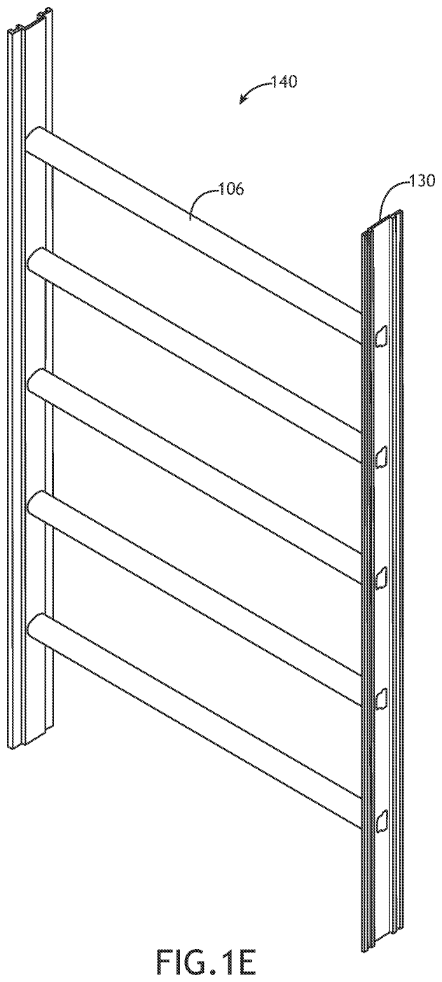

FIG. 1A illustrates a work table 150 including an outer side rail 130, in accordance with one or more embodiments of the present disclosure. The work table 150 may include legs 104 and a frame 140 such as, but not necessarily limited to, a table top. For example, the frame 140 may be a table top that includes the outer side rail 130 and cross members 106 as shown.

The present disclosure may be, in some ways, an improvement to the work table of U.S. Pat. No. 8,727,327, or at least potentially applicable in one or more respects. In one or more embodiments, the work table 150 and/or outer side rail 130 of the present disclosure includes one or more components, configurations, functionality, materials, and/or the like as disclosed by the work table and/or elongated members in U.S. Pat. No. 8,727,327, issued May 20, 2014, which is herein incorporated by reference in the entirety.

The frame 140 may be configured to be supported by the legs 104, as defined in a vertical direction (e.g., in the Z-direction, and the like).

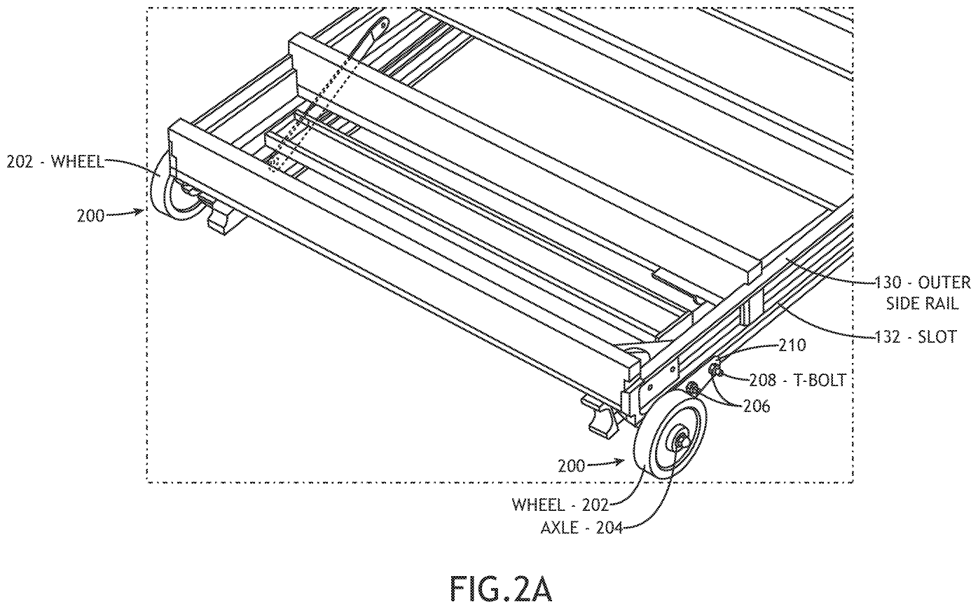

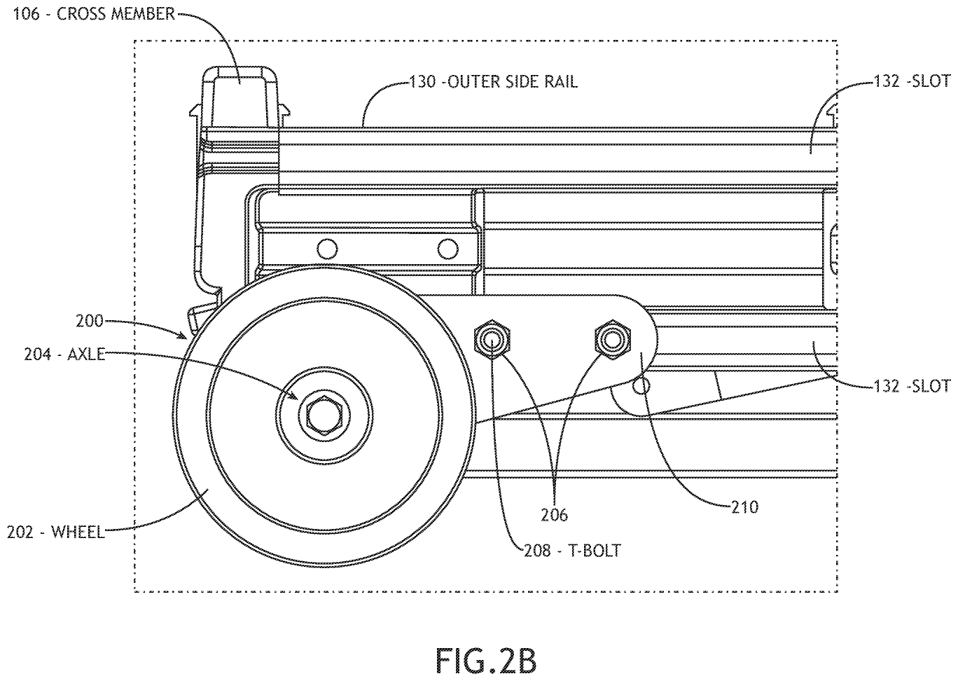

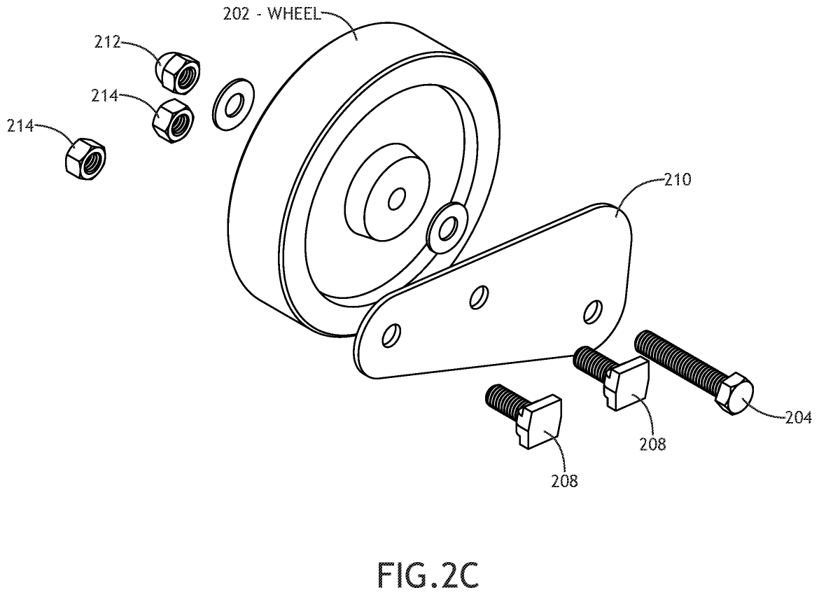

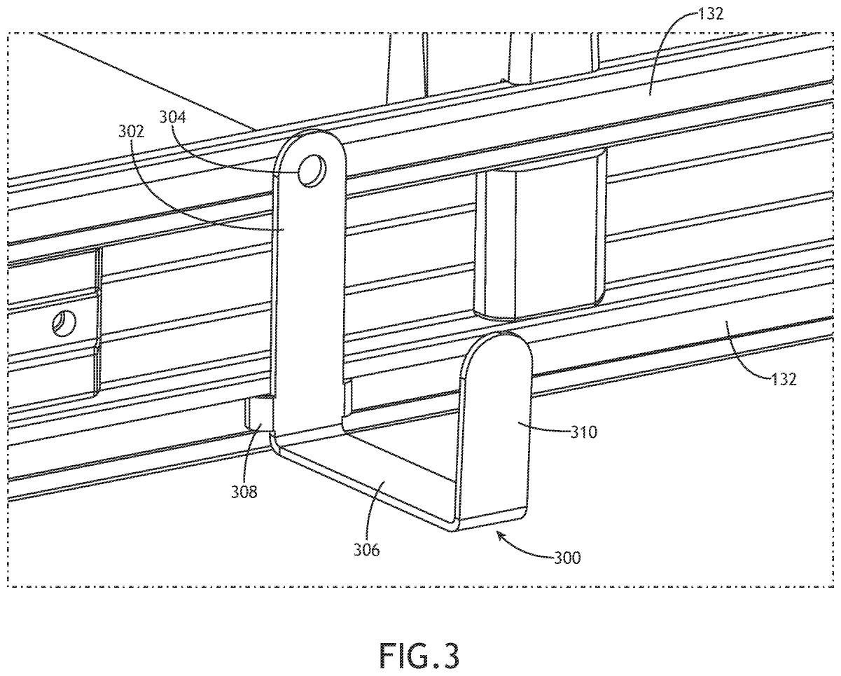

The outer side rail 130 includes one or more slots 132. For example, the outer side rail 130 may include a first slot 132 and a second slot 132. The first slot 132 may be parallel to the second slot 132. The outer side rail 130 may be configured to receive one or more attachments (e.g., see wheel attachment in FIG. 2A and bracket attachment in FIG. 3). For example, the slots 132 may be configured to receive the one or more attachments from an outward facing direction (e.g., X-direction) that is perpendicular to the vertical direction.

In embodiments, the slots 132 are any length. For example, the slots 132 may extend along a full length of the outer side rail 130 in a Y-direction.

In embodiments, the slots 132 are configured to receive protrusions 206 (e.g., T-bolts 208, hooks, and the like) of the one or more attachments. For example, the first slot 132 may comprise a first T-slot and the second slot 132 may comprise a second T-slot. The first slot 132 and the second slot 132 may be configured to receive a T-bolt 208. See FIG. 2C for an example T-bolt 208 and FIG. 1C for an example cross-sectional shape of a slot 132.

In some embodiments, a cross member 106 includes one or more tabs 136. For example, each cross member 136 may include multiple tabs 136 along the length of the cross member 106 on each side of the cross member 106. The tabs 136 may be configured to receive corresponding surfaces of inserts. For example, an insert may be a tray insert configured to be received between the cross members 106 and to snap into the tabs 136. In this regard, the tabs 136 may be configured to retain the insert.

FIG. 1B illustrates an enlarged view of the work table 150 of FIG. 1A illustrating the first slot 132 and the second slot 132 of the outer side rail 130 in more detail, in accordance with one or more embodiments of the present disclosure.

FIG. 1C illustrates a view of a cross-sectional area of the outer side rail 130, in accordance with one or more embodiments of the present disclosure. As shown, the outer side rail 130 may be configured to be fabricated via a swaging technique.

In embodiments, the swaging technique may allow for a one-piece construction of the outer side rail 130. The swaging technique may be used to form a one-piece, monolithic, and uniform-material outer side rail 130 that is less prone to weakening from stress and wear, reducing the likelihood of fractures or breaks. Additionally, this one-piece construction may reduce the complexity of the work table 150, reduce part count, reduce fabrication labor (e.g., assembling, welding, etc.), and thereby reduce costs.

In embodiments, the swaging technique may include introducing a predetermined limit of strain on the material being formed. By applying a predetermined limit of strain, the swaging technique may increase the strength of the material being formed, allowing for a strengthened section of the frame 140 and an increased load-bearing capacity of the work table 150. The swaging process is often more economical and efficient than stamping since it moves, not removes, metal and can be used to remodel existing products with minimal waste.

To be more configured to be fabricated using a swaging technique, the outer side rail 130 may, for example, have a consistent cross-sectional area along a length, or along the full length of the outer side rail 130. Further, for example, a thickness of walls and/or arrangement of the walls of the outer side rail 130 may be configured such that the design is producible via a swaging technique. In this way, the outer side rail 130 may be configured to be produced via a swaging technique.

Referring to FIG. 1C, examples of dimensions of an outer side rail 130 are discussed below. It should be noted that such dimensions are example dimensions, are not necessarily limiting, and that a variety of shapes and dimensions may be used. A height 170 may be 1 inch or more, 2 inches or more, or (as shown) 4 inches or more. An inside slot height 172 may be 0.25 inches or more, or (as shown) 0.876 inches or more. An inside slot depth 174 may be 0.1 inches or more, or (as shown) 0.225 inches or more. A slot retaining wall 176, 180 may be 0.1 inches or more, or (as shown) 0.225 inches or more. A slot void height 178 may be 0.2 inches or more, or (as shown) 0.45 inches or more. A slot gap 182 (e.g., distance between inner surfaces of slots 132) may be 1 inch or more, or (as shown) 2 inches or more. A wall thickness 184 of one wall, multiple walls, and/or all walls may be any thickness, or combination of thicknesses, such as 0.062 inches (as shown).

The slots 132 may be C-shaped and structurally connected via a connecting gap wall across the slot gap 182 as shown.

In some embodiments, the T-bolt heads of the T-bolts 208 are more narrow in one dimension than the other such that the T-bolts 208 may only be inserted through the slot void height 178 in one orientation. After inserting and turning the T-bolts 208 a quarter turn, the longer dimension of the T-bolts 208 may catch (and be retained by) the slot retaining walls 176, 180. In other embodiments, although not illustrated, a larger cutout portion of the slot retaining walls 176, 180 allows inserting the T-bolts 208 at any orientation and then sliding the T-bolts 208 left or right into a non-cutout portion of the slots 132, resulting in the T-bolts 208 being retained by the slot retaining walls 176, 180. These are merely examples, and a variety of mechanisms, shapes, and methods allow for selectively retaining the one or more attachments in the slots 132, while still allowing the attachments to be removable when desired.

FIG. 1D illustrates the outer side rail 130 including cross member voids 134, in accordance with one or more embodiments of the present disclosure. The cross member voids 134 may be configured to receive cross members 106 and may include cutouts. For example, the cross member voids 134 may be fabricated by removing material via any known method in the art such as via laser cutting, plasma cutting, water jet cutting, and the like.

FIG. 1E illustrates the frame 140, in accordance with one or more embodiments of the present disclosure. As shown, the frame 140 may include two outer side rails 130 coupled to a plurality of cross members 106 via the cross member voids 134.

FIG. 2A illustrates the work table 150 including a wheel attachment 200, in accordance with one or more embodiments of the present disclosure. When the work table 150 is in a collapsed and flattened configuration, the wheel attachment 200 may allow for transporting the work table 150 along the ground.

As shown in FIG. 2A, the work table 150 is in such a collapsed configuration, where the legs 104 are uncoupled from the cross members 106 and folded up under the frame 140 using a hinge mechanism. The hinge mechanism includes one or more support members 102 coupled to the legs 104.

In some embodiments, the wheel attachment 200 may be configured to be received by the outer side rail 130 via at least one of the first slot 132 or the second slot 132, such as the lowest slot.

As shown, the work table 150 includes a second wheel attachment 202 configured to be received by a second outer rail at an opposite side of the work table 150. The second wheel attachment 200 may be symmetrical in function and design to the (first) wheel attachment 200.

As mentioned, the hinge mechanisms are configured to allow a collapsible leg 104 to move between the extended position (e.g., see FIG. 1A) and a collapsed position (e.g., see FIG. 2A). The collapsed position may be up under the frame 140 (e.g., table top) of the work table 150 such that the collapsible leg 104 is substantially parallel (e.g., within 10 degrees) with the table top. In this regard, the hinge mechanism allows for portable and compact storage of the work table 150.

FIG. 2B illustrates a side view of the work table 150 including the wheel attachment 200, in accordance with one or more embodiments of the present disclosure. As shown, the wheel attachment 200 may include a wheel 202 that is positioned and configured for rolling the work table 150 along the ground when the legs 104 are in a collapsed position.

As shown, the wheel 202 may extend below the legs 104, relative to the vertical direction, when the legs 104 are in the collapsed position. Extending the wheels 202 below the legs 104 allows for the wheels to contact the ground. In this regard, the work table 150 may be collapsed for portability and the wheels 202 may be utilized to transport the work table 150 along the ground. Note that the wheel attachment 200 is an example of and a variety of attachments providing a variety of functionality may be used with the embodiments of the present disclosure.

FIG. 2C illustrates an exploded assembly view of the wheel attachment 200, in accordance with one or more embodiments of the present disclosure. As shown, the wheel attachment 200 may include a wheel 202, an axle 204, protrusions such as T-bolts 208, a wheel attachment frame 210, an axle nut 212, and T-bolt nuts 214.

The wheel 202 may be configured to be coupled to the axle 204. The axle 204 may be configured to be coupled to the wheel attachment frame 210. The protrusion 206 may include (or be) a T-bolt 208, or any other protrusion configured to couple to a slot 132. The wheel attachment frame 210 may be configured to be coupled to the protrusion 206 via a hole. The T-bolt 208 may be configured to be received by the first slot 132 and/or the second slot 132. The axle nut 212 may be configured to be coupled to the axle 204. The T-bolt nut 214 may be configured to be coupled to the T-bolt 208.

Note that the number, shape, arrangement, and the like of the components of the wheel attachment 200 of the present disclosure is merely an example for illustrative purposes and the wheel attachment may generally include any number, shape, arrangement, and the like of components.

FIG. 3 illustrates the work table 150 including a bracket attachment 300, in accordance with one or more embodiments of the present disclosure. The bracket attachment 300 may be configured to be received by the outer side rail 130 via the first slot 132.

As shown, the bracket attachment 300 may include a hole 304 configured to receive a T-bolt 208. The bracket attachment 300 may also include two tabs 308 configured to extend at an inward facing direction relative to the work table 150. The two tabs 308 may be configured to be received by the second slot 132, make contact with the second slot 132, and thereby constrain a movement of the bracket attachment 300.

The bracket attachment 300 may also include an extension member 306 configured to extend at an outward facing direction relative to the work table 150. The extension member 306 may include an orthogonal portion 310. The orthogonal portion 310 may be configured to extend along the vertical direction relative to the work table 150.

In embodiments, the extension member 306 may be any length. For example, the extension member 306 may be at least four inches long.

In embodiments, generally, an attachment may be configured to be secured/fixed in place via a protrusion 106 such as a T-bolt 208. For example, a tightening of one or more T-bolt nuts 214 may pinch one or more portions of the slot 132 with the T-bolt 208 such that the attachment is fixed/locked in place via friction. However, note that any method of locking the attachment may be used, such as a clamp with a handle and the like.

Referring again generally to FIGS. 1A-3, it is to be understood that FIGS. 1A-3 are provided solely for illustrative purposes and should not be interpreted as limiting. Rather, side rails may generally provide various slots to allow for receiving one or more attachments. Further, the one or more attachments may include any attachment disclosed herein, known in the art, or otherwise useful when attached to a side rail. In this way, the illustrations and examples referring to operation in the context of the outer side rail 130 are merely illustrations. Further, the illustrations and examples that refer to particular components (e.g., the protrusions, the legs, support members, and the like) are also merely illustrations. It is contemplated herein that a work table 150 as disclosed herein may comprise any number or type of components.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A work table comprising:
legs; and
a frame supported by the legs as defined in a vertical direction, the frame comprising:
an outer side rail comprising a first slot parallel to a second slot, wherein the outer side rail is configured to receive one or more attachments via at least one of the first slot or the second slot.

2. The work table of claim 1, wherein the first slot comprises a first T-slot and the second slot comprises a second T-slot, wherein the first T-slot and the second T-slot are configured to receive T-bolts of the one or more attachments.

3. The work table of claim 1, wherein the outer side rail is configured to be fabricated via a swaging technique.

4. The work table of claim 1, wherein the first slot and the second slot extend along a full length of the outer side rail.

5. The work table of claim 1, wherein the first slot and the second slot are configured to receive the one or more attachments from an outward facing direction that is perpendicular to the vertical direction.

6. The work table of claim 5, wherein the work table comprises a wheel attachment configured to be received by the outer rail via at least one of the first slot or the second slot.

7. The work table of claim 6, wherein the wheel attachment includes a wheel that is positioned and configured for rolling the work table along the ground when the legs are in a collapsed position.

8. The work table of claim 7, wherein the wheel extends below the legs, relative to the vertical direction, when the legs are in a collapsed position.

9. The work table of claim 6, wherein the work table comprises a second wheel attachment configured to be received by a second outer rail at an opposite side of the work table.

10. The work table of claim 1, wherein the work table comprises a bracket attachment configured to be received by the outer rail via the first slot.

11. The work table of claim 10, wherein the bracket attachment comprises a hole configured to receive a T-bolt.

12. The work table of claim 10, wherein the bracket attachment comprises two tabs configured to extend at an inward facing direction relative to the work table, wherein the two tabs are configured to be received by the second slot, make contact with the second slot, and thereby constrain a movement of the bracket attachment.

13. The work table of claim 10, wherein the bracket attachment comprises an extension member configured to extend at an outward facing direction relative to the work table.

14. The work table of claim 10, wherein the extension member of the bracket attachment is at least four inches in length.
